(19) United States
(12) Patent Application Publication
(10) Pub. No.: US 2023/0054479 A1
(43) Pub. Date: Feb. 23, 2023

(54) COOLING DEVICE FOR HIGH VOLTAGE BATTERY

(71) Applicant: HYUNDAI MOBIS Co., Ltd., Seoul (KR)

(72) Inventor: Jae Woong CHOI, Incheon (KR)

(73) Assignee: HYUNDAI MOBIS Co., Ltd., Seoul (KR)

(21) Appl. No.: 17/851,559

(22) Filed: Jun. 28, 2022

(30) Foreign Application Priority Data
Aug. 20, 2021 (KR) 10-2021-0110480

(51) Int. Cl. H01M 10/6568; H01M 10/613; H01M 10/6556

(52) U.S. Cl. CPC H01M 10/6568; H01M 10/613; H01M 10/6556

(57) ABSTRACT

A cooling device for a high voltage battery may include: a plurality of battery coolers mounted on the plurality of high voltage batteries, respectively, and configured to cool the high voltage batteries through cooling fluid; a fluid distributor configured to receive cooling fluid from outside, and distribute the cooling fluid to the battery coolers; and a flow control member coupled to the fluid distributor, and configured to control a flow rate of the cooling fluid distributed to the battery coolers.

### CROSS-REFERENCE TO RELATED APPLICATION

This application claims the benefit of priority to Korean Patent Application No. 10-2021-0110480, filed on Aug. 20, 2021 in the Korean Intellectual Property Office, the disclosure of which is incorporated herein by reference in its entirety.

### BACKGROUND

### 1. Technical Field

The present disclosure relates to a cooling device for a high voltage battery, and more particularly, to a cooling device for a high voltage battery, which efficiently cools heat generated in a plurality of high voltage batteries.

### 2. Related Art

In order to solve the environmental preservation problem and prepare for fossil fuel depletion all over the world, the development of eco-friendly vehicles such as an HEV (Hybrid Electric Vehicle), PHEV (Plug-in Hybrid Electric Vehicle), FCEV (Fuel Cell Electric Vehicle), and EV (Electric Vehicle) has attracted attention.

Such eco-friendly vehicles have a disadvantage in that they have a shorter mileage than existing internal combustion engine vehicles.

In order to overcome such a disadvantage, a method of raising the energy density of a battery which is necessarily mounted in an eco-friendly vehicle is used. However, due to the technical limitation of the method, the method increases the mileage of the vehicle mainly by mounting a larger number of battery cells to increase the capacity of the battery.

Therefore, the numbers of batteries included in HEV, PHEV, and EV have a relation of HEV<PHEV<EV, and a thermal management system for the increased batteries needs to be added.

Furthermore, in order to manage the performance and lifespan of batteries mounted in an eco-friendly vehicle, the temperatures of the batteries need to be maintained at a constant level, and a temperature difference between the respective batteries needs to be minimized.

Therefore, it is very important to supply a uniform amount of refrigerant, which can exhibit cooling performance, to the thermal management system for the increased batteries.

For this configuration, a battery cooler is used, to which the refrigerant is supplied to cool heat generated from the corresponding battery.

The battery cooler contains liquid such as cooling water or refrigerant therein, and cools the battery by directly or indirectly bringing the liquid into thermal contact with the battery.

When the refrigerant is supplied to two or more battery coolers, a distributor is used to supply an equal amount of refrigerant to each of the battery coolers.

Depending on the layout of the specification of an electric vehicle, a plurality of batteries may be mounted. In this case, the batteries may be disposed at different distances from the distributor, depending on the layout of the batteries.

Therefore, a plurality of high voltage batteries disposed at different distances from the distributor may have different pressure losses depending on the sizes of the battery coolers and the length of a pipe.

In this case, the flow rate is inevitably concentrated on a region whose pressure loss is low. Thus, severe temperature deviations occur among the plurality of batteries. As a result, the durability of the high voltage batteries may be degraded, or the lifespan of the high voltage batteries may be reduced.

That is, in order to solve the above-described problem, the diameter of a flow path formed in the conventional distributor needs to be newly set at each time, according to the positions and sizes of the batteries mounted in the vehicle, such that each of the battery coolers exhibits required cooling performance.

For the above-described reasons, manufacturers in the corresponding field have been seeking for a method for efficiently cooling a plurality of batteries having different capacities and located at different positions, but have not acquired a satisfactory result until now.

### SUMMARY

Various embodiments are directed to a cooling device for a high voltage battery, which can efficiently cool a plurality of high voltage batteries.

The above-described the other objects, the advantages and characteristics of the present disclosure and a method for achieving the objects, advantages and characteristics will be clearly understood through embodiments to be described below in detail with reference to the accompanying drawings.

In an embodiment, a cooling device for a high voltage battery may include: a plurality of battery coolers mounted on the plurality of high voltage batteries, respectively, and configured to cool the high voltage batteries through cooling fluid; a fluid distributor configured to receive cooling fluid from outside, and distribute the cooling fluid to the battery coolers; and a flow control member coupled to the fluid distributor, and configured to control a flow rate of the cooling fluid distributed to the battery coolers.

The battery cooler may include: a first cooler unit mounted on a first battery which is any one of the plurality of high voltage batteries, and configured to cool the first battery; and a second cooler unit spaced apart by a predetermined distance from the first cooler unit, mounted on a second battery which is another one of the plurality of high voltage batteries, and configured to cool the second battery, wherein the fluid distributor is disposed at a position closer to the second cooler unit than the first cooler unit.

The fluid distributor may include: a body part forming a body of the fluid distributor; an introduction path positioned at a first surface of the body part, and configured to transfer cooling fluid to a corresponding battery cooler among the plurality of battery coolers; a discharge path positioned at the first surface of the body part, and configured to transfer the cooling fluid, transferred from the corresponding battery cooler, into the body part; and a connection path positioned at a second surface of the body part, and configured to transfer cooling fluid, introduced from the outside, to the introduction path.

The introduction path may be located at a position closer to the connection path than the discharge path.

The introduction path may include: a first introduction path positioned at the first surface of the body part and configured to transfer cooling fluid to the first cooler unit; and a second introduction path positioned at the first surface of the body part and configured to transfer cooling fluid to the second cooler unit.

The flow control member may be coupled to the second introduction path.

The flow control member may include a hollow cylindrical shape and may be coupled to the second introduction path, and have an inner diameter smaller than an inner diameter of the first introduction path.

The flow control member may be screwed to the second introduction path.

The discharge path may include: a first discharge path positioned at the first surface of the body part, and configured to transfer cooling fluid, transferred from the first cooler unit, into the body part; and a second discharge path positioned at the first surface of the body part, and configured to transfer cooling fluid, transferred from the second cooler unit, into the body part.

The connection path may include: a first connection path positioned at the second surface of the body part, and configured to transfer cooling fluid, introduced from the outside, to the first introduction path and the second introduction path; and a second connection path positioned at the second surface of the body part, and configured to discharge cooling fluid, received from the first discharge path and the second discharge path, to an outside of the body part.

The second connection path may be positioned under the first connection path away from the first surface.

The first connection path may communicate with the first discharge path and the second discharge path, and the second connection path may communicate with the first introduction path and the second introduction path.

The first cooler unit may include: a first cooling channel through which cooling fluid introduced from the fluid distributor flows, and which directly abuts on the first battery so as to cool the first battery; a first header configured to introduce the cooling fluid into the first cooling channel; the first introduction pipe having a first end connected to the first header, and a second end connected to the first introduction path such that cooling fluid is introduced into the first introduction pipe; and a first discharge pipe having a first end connected to the first header and a second end connected to the first discharge path, and configured to discharge cooling fluid.

The second cooler unit may include: a second cooling channel through which cooling fluid introduced from the fluid distributor flows, and which directly abuts on the second battery so as to cool the second battery; a second header configured to introduce the cooling fluid into the second cooling channel; the second introduction pipe having a first end connected to the second header, and a second end connected to the second introduction path such that cooling fluid is introduced into the second introduction pipe; and a second discharge pipe having a first end connected to the second header and a second end connected to the second discharge path, and configured to discharge cooling fluid.

In another embodiment, a cooling device for a high voltage battery may include: a plurality of battery coolers mounted on the plurality of high voltage batteries, respectively, and configured to cool the high voltage batteries through cooling fluid; and a fluid distributor configured to receive cooling fluid from outside, and distribute the cooling fluid to the battery coolers. The fluid distributor may include: a body part forming the body of the fluid distributor; an introduction path positioned at one surface of the body part, and configured to transfer cooling fluid to the battery coolers; a discharge path positioned at the one surface of the body part, and configured to transfer the cooling fluid, transferred from the battery cooler, into the body part; a connection path positioned at the other surface of the body part, and configured to transfer cooling fluid, introduced from the outside, into the introduction path; and a sealing cap configured to seal a processing hole included in the outer surface of the body part, when a cooling flow path is processed in the body part.

In accordance with the present disclosure, the flow control member is coupled to the second introduction path of the fluid distributor connected to the second cooler unit that is relatively close to the fluid distributor, and has an inner diameter smaller than the inner diameter of the first introduction path, such that the pressure of cooling fluid flowing through the first introduction path and the pressure of cooling fluid flowing through the second introduction path become similar to each other. Therefore, the flow rate of the cooling fluid flowing through the second introduction pipe may be effectively induced to the first introduction pipe.

Furthermore, although the length of the first introduction pipe is larger than the length of the second introduction pipe, the pressure of the cooling fluid flowing through the first introduction pipe and the pressure of the cooling fluid flowing through the second introduction pipe are controlled to similar values by the flow control member, such that the cooling fluid can be uniformly distributed to the first cooler unit and the second cooler unit. Therefore, it is possible to remove inconvenience which occurs when the fluid distributor needs to be newly manufactured by differently setting the inner diameter of the second introduction path depending on the distances to the first cooler unit and the second cooler unit.

### BRIEF DESCRIPTION OF THE DRAWINGS

FIG. 1 is a perspective view illustrating that a cooling device for a high voltage battery in accordance with an embodiment of the present disclosure is used.

FIG. 2 is a perspective view illustrating the cooling device for a high voltage battery in accordance with the embodiment of the present disclosure.

FIG. 3 is an exploded perspective view illustrating pipes and a fluid distributor of the cooling device for a high voltage battery in accordance with the embodiment of the present disclosure.

FIG. 4 is a cross-sectional view taken along line A-A′ of FIG. 3.

FIG. 5 is a cross-sectional view taken along line B-B′ of FIG. 3.

FIG. 6 is a side view illustrating the fluid distributor of the cooling device for a high voltage battery in accordance with the embodiment of the present disclosure.

### DETAILED DESCRIPTION

Embodiments of the present disclosure are provided to more completely describe the present disclosure to those skilled in the art. The following embodiments may be modified into various other forms, and the scope of the present disclosure is not limited to the following embodiments. Rather, the embodiments are provided to make the present disclosure more reliable and complete, and to completely convey the spirit of the present disclosure to those skilled in the art. In the drawings, components are exaggerated for convenience and clarity of description, and like reference numerals represent the same elements. In this specification, the term “and/or” includes any one of corresponding listed items and one or more combinations thereof.

The terms used in this specification are used to describe a specific embodiment, and are not intended to limit the present disclosure.

In this specification, the terms of a singular form may include plural forms unless referred to the contrary. Furthermore, in this specification, the terms “comprise” and/or “comprising” specify the presence of a shape, number, step, operation, member, element, and/or a group thereof, and do not exclude the presence or addition of one or more other shapes, numbers, steps, operations, members, elements, and groups thereof.

Hereafter, preferred embodiments of the present disclosure will be described in detail with reference to the accompanying drawings.

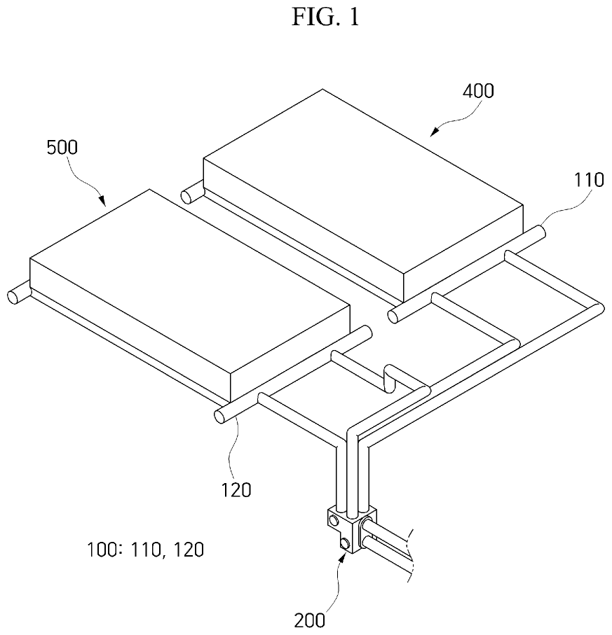

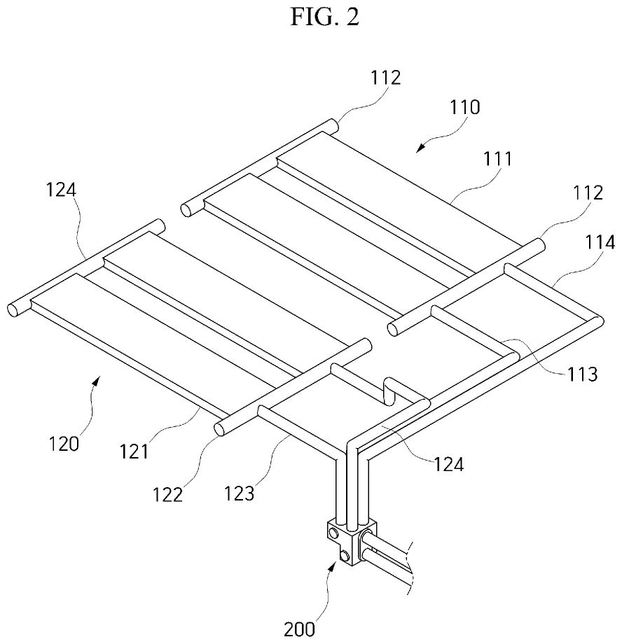

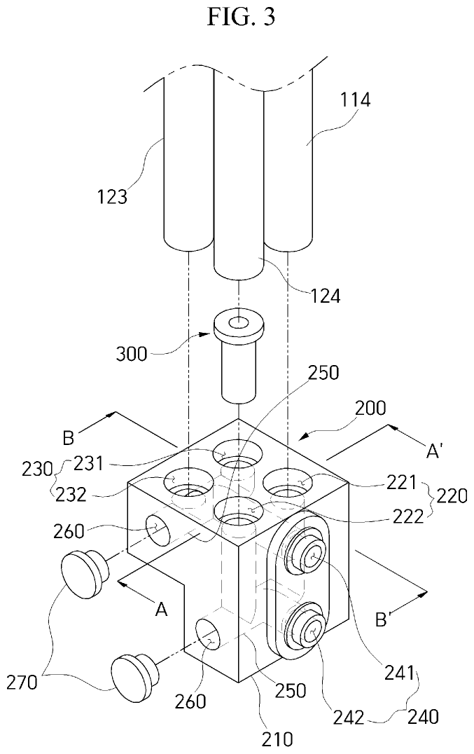

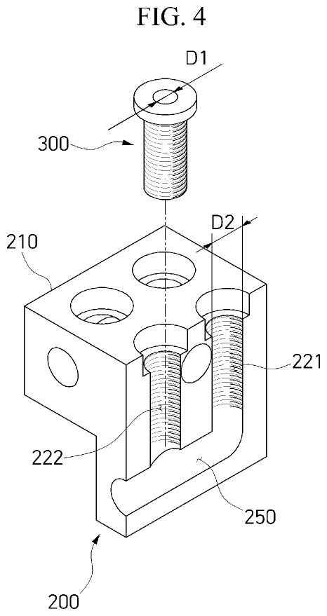

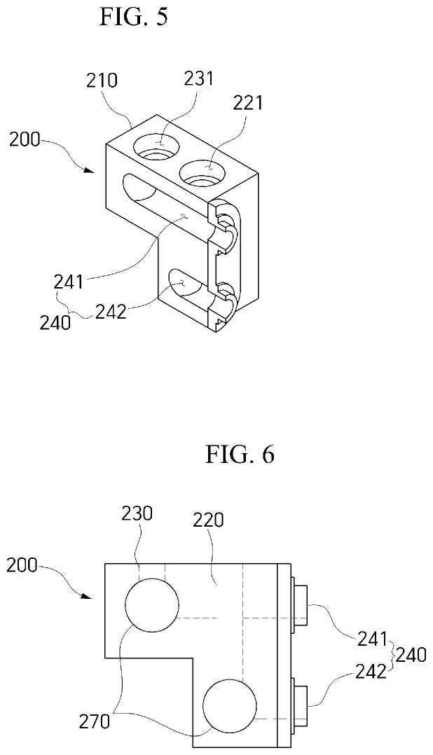

FIG. 1 is a perspective view illustrating that a cooling device for a high voltage battery in accordance with an embodiment of the present disclosure is used, FIG. 2 is a perspective view illustrating the cooling device for a high voltage battery in accordance with the embodiment of the present disclosure, FIG. 3 is an exploded perspective view illustrating pipes and a fluid distributor of the cooling device for a high voltage battery in accordance with the embodiment of the present disclosure, FIG. 4 is a cross-sectional view taken along line A-A′ illustrated in FIG. 3, FIG. 5 is a cross-sectional view taken along line B-B′ illustrated in FIG. 3, and FIG. 6 is a side view illustrating the fluid distributor of the cooling device for a high voltage battery in accordance with the embodiment of the present disclosure.

Referring to FIGS. 1 to 6, the cooling device for a high voltage battery, which cools a plurality of high voltage batteries, includes a battery cooler 100, a fluid distributor 200, and a flow control member 300.

The battery cooler 100 is provided as a plurality of battery coolers corresponding to the number of high voltage batteries. The plurality of battery coolers are mounted on the respective high voltage batteries, and serve to cool the high voltage batteries.

The battery cooler 100 contains cooling fluid flowing therethrough, and cools heat generated from the high voltage battery through the cooling fluid.

Such a battery cooler 100 includes a first cooler unit 110 and a second cooler unit 120.

The first cooler unit 110 is mounted on a first battery 400 which is any one of the plurality of high voltage batteries, and cools the first battery 400.

The first cooler unit 110 includes a first cooling channel 111, a first header 112, a first introduction pipe 113, and a first discharge pipe 114.

The first cooling channel 111 forms the body of the first cooler unit 110, and directly abuts on the first battery 400 so as to cool the first battery 400.

For this operation, the cooling fluid introduced from the fluid distributor 200 flows through the first cooling channel 111.

The first header 112 is connected to an end of the first introduction pipe 113, and formed in a cylindrical shape.

When the cooling fluid is introduced from the fluid distributor 200, the first header 112 introduces the cooling fluid into the first cooling channel 111.

That is, the first header 112 may have a structure that communicates with the inside of the first cooling channel 111.

The first introduction pipe 113 has one end connected to the first header 112 and the other end connected to a first introduction path 221 of the fluid distributor 200.

That is, the first introduction pipe 113 introduces the cooling fluid, introduced from the fluid distributor 200, into the first header 112.

The first introduction pipe 113 may be disposed at a portion of the first header 112, one-sided in one direction thereof.

The first discharge pipe 114 has one end connected to the first header 112 and the other end connected to a first discharge path 231 of the fluid distributor 200.

That is, when the cooling fluid introduced into the first cooling channel 111 through the first introduction pipe 113 flows through the flow path of the first cooling channel 111, cools heat generated by a high voltage battery, and is then discharged to the first header 112, the first discharge pipe 114 discharges the discharged cooling fluid to the fluid distributor 200.

The first discharge pipe 114 may be disposed at a region of the first header 112, which does not overlap the first introduction pipe 113, i.e. a portion of the first header 112, one-sided in the other direction thereof.

The second cooler unit 120 is spaced apart by a predetermined distance from the first cooler unit 110, and mounted on a second battery 500, which is the other of the plurality of high voltage batteries, so as to cool the second battery 500.

The second cooler unit 120 includes a second cooling channel 121, a second header 122, a second introduction pipe 123, and a second discharge pipe 124.

The second cooling channel 121 forms the body of the second cooler unit 120, and directly abuts on the second battery 500 so as to cool the second battery 500.

For this operation, the cooling fluid introduced from the fluid distributor 200 flows through the second cooling channel 121.

The second header 122 is connected to an end of the second introduction pipe 123, and formed in a cylindrical shape.

When the cooling fluid is introduced from the fluid distributor 200, the second header 122 introduces the cooling fluid into the second cooling channel 121.

That is, the second header 122 may have a structure that communicates with the inside of the second cooling channel 121.

The second introduction pipe 123 has one end connected to the second header 122 and the other end connected to a second introduction path 222 of the fluid distributor 200.

That is, the second introduction pipe 123 introduces the cooling fluid, introduced from the fluid distributor 200, into the second header 122.

The second introduction pipe 123 may be disposed at a portion of the second header 122, one-sided in one direction thereof.

The second discharge pipe 124 has one end connected to the second header 122 and the other end connected to a second discharge path 232 of the fluid distributor 200.

That is, when the cooling fluid introduced into the second cooling channel 121 through the second introduction pipe 123 flows through the flow path of the second cooling channel 121, cools heat generated by the high voltage battery, and is then discharged to the second header 122, the second discharge pipe 124 discharges the discharged cooling fluid to the fluid distributor 200.

The second discharge pipe 124 may be disposed at a region of the second header 122, which does not overlap the second introduction pipe 123, i.e. a portion of the second header 122, one-sided in the other direction thereof.

The fluid distributor 200 receives cooling fluid from the outside, and distributes the cooling fluid to the battery cooler 100.

The fluid distributor 200 in accordance with the embodiment of the present disclosure is disposed at a position closer to the second cooler unit 120 than the first cooler unit 110.

Thus, the first introduction pipe 113 and the first discharge pipe 114 have larger lengths than the second introduction pipe 123 and the second discharge pipe 124, respectively.

Such a fluid distributor 200 includes a body part 210, an introduction path 220, a discharge path 230, and a connection path 240.

The body part 210 forms the body of the fluid distributor 200, and cooling fluid from the outside is introduced into the body part 210.

The introduction path 220 may be formed at one surface of the body part 210 and located at a position closer to the connection path 240 than the discharge path 230.

The introduction path 220 introduces the cooling fluid, introduced from the outside, into the battery cooler 100.

The introduction path 220 includes the first introduction path 221 and the second introduction path 222.

The first introduction path 221 is formed at one surface of the body part 210, and transfers the cooling fluid to the first cooler unit 110.

Specifically, the first introduction path 221 is coupled to the first introduction pipe 113 that introduces the cooling fluid to the first cooler unit 110.

Therefore, the first introduction path 221 may easily transfer the cooling fluid, introduced from the outside through the first cooling channel 111, to the first cooler unit 110.

The first introduction path 221 may be formed at a corner region on the one surface of the body part 210.

The second introduction path 222 is formed at the one surface of the body part 210, and transfers cooling fluid to the second cooler unit 120.

Specifically, the second introduction path 222 is coupled to the second introduction pipe 123 that introduces the cooling fluid to the second cooler unit 120.

Therefore, the second introduction path 222 may easily transfer the cooling fluid, introduced from the outside through the second cooling channel 121, to the second cooler unit 120.

The second introduction path 222 may be formed at a corner region which does not overlap the first introduction path 221, among the corner regions of the one surface of the body part 210.

The discharge path 230 is formed at the one surface of the body part 210, and serves to introduce the cooling fluid, discharged from the battery cooler 100, into the body part 210.

The discharge path 230 includes the first discharge path 231 and the second discharge path 232.

The first discharge path 231 is formed at the one surface of the body part 210, and introduces the cooling fluid, transferred from the first cooler unit 110, into the body part 210.

Specifically, the first discharge path 231 is coupled to the first discharge pipe 114 through which the cooling fluid discharged from the first cooler unit 110 flows.

Therefore, the first discharge path 231 may easily introduce the cooling fluid, discharged from the first cooler unit 110 through the first discharge pipe 114, into the body part 210.

The first discharge path 231 may be formed at a corner region which does not overlap the first introduction path 221 and the second introduction path 222, among the corner regions of the one surface of the body part 210.

The second discharge path 232 is formed at the one surface of the body part 210, and serves to introduce the cooling fluid, transferred from the second cooler unit 120, into the body part 210.

Specifically, the second discharge path 232 is coupled to the second discharge pipe 124 through which the cooling fluid discharged from the second cooler unit 120 flows.

Therefore, the second discharge path 232 may easily introduce the cooling fluid, discharged from the second cooler unit 120 through the second discharge pipe 124, into the body part 210.

The second discharge path 232 may be formed at a corner region which does not overlap the first introduction path 221, the second introduction path 222, and the first discharge path 231, among the corner regions of the one surface of the body part 210.

The connection path 240 is formed at the other surface of the body part 210, and serves to introduce the cooling fluid, introduced from the outside, into the battery cooler 100 or discharge the cooling fluid, discharged from the battery cooler 100, from the body part 210.

The connection path 240 includes a first connection path 241 and a second connection path 242.

The first connection path 241 is formed on the other surface of the body part 210, and serves to transfer cooling fluid, introduced from the outside of the body part 210, to the first introduction path 221 and the second introduction path 222.

Therefore, the first connection path 241 communicates with the first introduction path 221 and the second introduction path 222, which form the introduction path 220, and forms the cooling flow path 250.

The first connection path 241 may be formed between the first introduction path 221 and the second introduction path 222.

Therefore, the first connection path 241 may cause the cooling fluid to uniformly flow into the first cooling channel 111 and the second cooling channel 121 through the first introduction path 221 and the second introduction path 222.

The second connection path 242 is formed at a region, which does not overlap the first connection path 241, on the other surface of the body part 210. Specifically, the second connection path 242 is formed under the first connection path 241. The cooling fluid which is discharged from the battery cooler 100 and introduced into the discharge path 230 is discharged to the outside of the body part 210.

Therefore, the second connection path 242 communicates with the first discharge path 231 and the second discharge path 232, which form the discharge path 230, and forms the cooling flow path 250.

The body part 210 has a processing hole 260 formed on an outer surface thereof, the processing hole 260 being used to process the cooling flow path 250 for forming a first inlet, a second inlet, a first outlet, and a second outlet.

The processing hole 260 is formed through the outer surface of the body part 210.

Thus, when the cooling fluid is introduced or discharged through the connection path 240, the cooling fluid inevitably leaks through the processing hole 260.

Therefore, the cooling device in accordance with the present disclosure may further include a sealing cap 270.

The sealing cap 270 serves to seal the processing hole 260. When the cooling fluid is introduced or discharged through the connection path 240, the sealing cap 270 may effectively block the cooling fluid from leaking through the processing hole 260 of the body part 210.

The discharge path 230 is formed at the one surface of the body part 210 and located at a position farther from the connection path 240 than the introduction path 220.

The discharge path 230 communicates with the first connection path 241 disposed at a higher level than the second connection path 242.

Therefore, the cooling flow path 250 in which the discharge path 230 and the first connection path 241 communicate with each other is disposed at a higher level than the cooling flow path 250 in which the introduction path 220 and the second discharge path 232 communicate with each other.

Therefore, as illustrated in FIG. 6, a lower region of the cooling flow path 250 in which the discharge path 230 and the first connection path 241 communicate with each other may be removed from the body part 210.

Thus, the entire weight of the body part 210 may be reduced, which makes it possible to effectively reduce the weight of the fluid distributor 200.

As described above, the fluid distributor 200 in accordance with the present disclosure is disposed at a position closer to the second cooler unit 120 than the first cooler unit 110. Thus, the first introduction pipe 113 has a larger length than the second introduction pipe 123.

Therefore, the pressure of the cooling fluid flowing through the first introduction pipe 113 is inevitably lost as much as the length of the first introduction pipe 113.

That is, in order to compensate for the pressure loss of the first introduction pipe 113 such that the pressure of the cooling fluid flowing through the first introduction path 221 and the pressure of the cooling fluid flowing through the second introduction path 222 to which the flow control member 300 is coupled become similar to each other, the flow control member 300 is coupled to the fluid distributor 200.

The flow control member 300 is formed in a hollow cylindrical shape, and coupled to the fluid distributor 200 so as to control the flow rate of the cooling fluid transferred to the battery cooler 100.

Specifically, the flow control member 300 is coupled to the second introduction path 222 of the fluid distributor 200, which is connected to the second cooler unit 120 closer to the fluid distributor 200 between the first cooler unit 110 and the second cooler unit 120.

The flow control member 300 has an inner diameter Dl smaller than an inner diameter D2 of the first introduction path 221.

Therefore, as the pressure of the cooling fluid flowing through the first introduction path 221 and the pressure of the cooling fluid flowing through the second introduction path 222 to which the flow control member 300 is coupled become similar to each other, the flow rate of the cooling fluid flowing through the second introduction pipe 123 having a relatively small length may be effectively induced to the first introduction pipe 113.

Thus, as the pressure of the cooling fluid flowing through the first introduction pipe 113 and the pressure of the cooling fluid flowing through the second introduction pipe 123 become similar to each other by the flow control member 300 even though the length of the first introduction pipe 113 and the length of the second introduction pipe 123 are different from each other, the cooling fluid may be uniformly distributed to the first cooler unit 110 and the second cooler unit 120.

For this reason, it is possible to reduce inconvenience, which occurs when the fluid distributor 200 needs to be newly manufactured by differently setting the inner diameter of the first introduction path depending on the distances to the first cooler unit 110 and the second cooler unit 120.

Furthermore, the flow control member 300 may have a screw thread formed on the outer circumferential surface thereof, and may be screwed to the second introduction path 222.

Thus, the flow control member 300 may be easily coupled to the first introduction path 221.

In the embodiment of the present disclosure, it has been described that the flow control member 300 and the first introduction path 221 are screwed to each other. However, as long as the flow control member 300 can be reliably coupled to the first introduction path 221, a coupling protrusion may be formed on the outer circumferential surface of the flow control member 300, a coupling groove may be formed on the inner circumferential surface of the first introduction path 221, and the coupling protrusion may be inserted into the coupling groove, such that the flow control member 300 and the first introduction path 221 are coupled to each other. However, the present disclosure is not limited thereto.

Furthermore, in the embodiment of the present disclosure, it has been described that the flow control member 300 is screwed to the second introduction path 222. However, when the second introduction path 222 to which the flow control member 300 is coupled has a small length, the flow control member 300 in accordance with another embodiment of the present disclosure may have a small thickness like a plain washer.

The flow control member 300 in accordance with the another embodiment of the present disclosure may have an inner diameter smaller than the inner diameter of the first introduction path 221, like the flow control member 300 in accordance with the embodiment of the present disclosure. Thus, the pressure of the cooling fluid flowing through the first introduction path 221 and the pressure of the cooling fluid flowing through the second introduction path 222 to which the flow control member 300 is coupled may become similar to each other, which makes it possible to effectively induce the flow rate of the cooling fluid, which flows to the second introduction pipe 123 having a relatively small length, to the first introduction pipe 113.

In the present disclosure, it has been described that the flow control member 300 is coupled to the second introduction path 222 of the second cooler unit 120 because the first cooler unit 110 is farther from the fluid distributor 200 than the second cooler unit 120. However, when the second cooler unit 120 is farther from the fluid distributor 200 than the first cooler unit 110, the flow control member 300 may be coupled to the first introduction path 221 that introduces the cooling fluid to the first cooler unit 110.

While various embodiments have been described above, it will be understood to those skilled in the art that the embodiments described are by way of example only. Accordingly, the disclosure described herein should not be limited based on the described embodiments.

What is claimed is:

1. A cooling device for a high voltage battery, which cools a plurality of high voltage batteries, the cooling device comprising:
a plurality of battery coolers mounted on the plurality of high voltage batteries, respectively, and configured to cool the high voltage batteries through cooling fluid;
a fluid distributor configured to receive cooling fluid from outside, and distribute the cooling fluid to the battery coolers; and
a flow control member coupled to the fluid distributor, and configured to control a flow rate of the cooling fluid distributed to the battery coolers.

2. The cooling device of claim 1, wherein the battery cooler comprises:
a first cooler unit mounted on a first battery which is any one of the plurality of high voltage batteries, and configured to cool the first battery; and
a second cooler unit spaced apart by a predetermined distance from the first cooler unit, mounted on a second battery which is another one of the plurality of high voltage batteries, and configured to cool the second battery,
wherein the fluid distributor is disposed at a position closer to the second cooler unit than the first cooler unit.

3. The cooling device of claim 2, wherein the fluid distributor comprises:
a body part forming a body of the fluid distributor;
an introduction path positioned at a first surface of the body part, and configured to transfer cooling fluid to a corresponding battery cooler among the plurality of battery coolers;
a discharge path positioned at the first surface of the body part, and configured to transfer the cooling fluid, transferred from the corresponding battery cooler, into the body part; and
a connection path positioned at a second surface of the body part, and configured to transfer cooling fluid, introduced from the outside, to the introduction path.

4. The cooling device of claim 3, wherein the introduction path is located at a position closer to the connection path than the discharge path.

5. The cooling device of claim 4, wherein the introduction path comprises:
a first introduction path positioned at the first surface of the body part and configured to transfer cooling fluid to the first cooler unit; and
a second introduction path positioned at the first surface of the body part and configured to transfer cooling fluid to the second cooler unit.

6. The cooling device of claim 5, wherein the flow control member is coupled to the second introduction path.

7. The cooling device of claim 5, wherein the flow control member includes a hollow cylindrical shape and is coupled to the second introduction path, and has an inner diameter smaller than an inner diameter of the first introduction path.

8. The cooling device of claim 5, wherein the flow control member is screwed to the second introduction path.

9. The cooling device of claim 5, wherein the discharge path comprises:
a first discharge path positioned at the first surface of the body part, and configured to transfer cooling fluid, transferred from the first cooler unit, into the body part; and
a second discharge path positioned at the first surface of the body part, and configured to transfer cooling fluid, transferred from the second cooler unit, into the body part.

10. The cooling device of claim 6, wherein the connection path comprises:
a first connection path positioned at the second surface of the body part, and configured to transfer cooling fluid, introduced from the outside, to the first introduction path and the second introduction path; and
a second connection path positioned at the second surface of the body part, and configured to discharge cooling fluid, received from the first discharge path and the second discharge path, to an outside of the body part.

11. The cooling device of claim 10, wherein the second connection path is positioned under the first connection path away from the first surface.

12. The cooling device of claim 10, wherein the first connection path communicates with the first discharge path and the second discharge path, and
the second connection path communicates with the first introduction path and the second introduction path.

13. The cooling device of claim 6, wherein the first cooler unit comprises:
a first cooling channel through which cooling fluid introduced from the fluid distributor flows, and which directly abuts on the first battery so as to cool the first battery;
a first header configured to introduce the cooling fluid into the first cooling channel;
the first introduction pipe having a first end connected to the first header, and a second end connected to the first introduction path such that cooling fluid is introduced into the first introduction pipe; and
a first discharge pipe having a first end connected to the first header and a second end connected to the first discharge path, and configured to discharge cooling fluid.

14. The cooling device of claim 13, wherein the second cooler unit comprises:
a second cooling channel through which cooling fluid introduced from the fluid distributor flows, and which directly abuts on the second battery so as to cool the second battery;
a second header configured to introduce the cooling fluid into the second cooling channel;
the second introduction pipe having a first end connected to the second header, and a second end connected to the second introduction path such that cooling fluid is introduced into the second introduction pipe; and
a second discharge pipe having a first end connected to the second header and a second end connected to the second discharge path, and configured to discharge cooling fluid.

15. A cooling device for a high voltage battery, which cools a plurality of high voltage batteries, the cooling device comprising:
a plurality of battery coolers mounted on the plurality of high voltage batteries, respectively, and configured to cool the high voltage batteries through cooling fluid; and
a fluid distributor configured to receive cooling fluid from outside, and distribute the cooling fluid to the battery coolers,
wherein the fluid distributor comprises:
a body part forming a body of the fluid distributor;
an introduction path positioned at a first surface of the body part, and configured to transfer cooling fluid to a corresponding battery cooler among the plurality of battery coolers;
a discharge path positioned at the first surface of the body part, and configured to transfer the cooling fluid, transferred from the corresponding battery cooler, into the body part;
a connection path positioned at a second surface of the body part, and configured to transfer cooling fluid, introduced from the outside, into the introduction path; and
a sealing cap configured to seal a processing hole included in a third surface of the body part, when a cooling flow path is processed in the body part.
